(19) United States
(12) Patent Application Publication
(10) Pub. No.: US 2009/0053385 A1
(43) Pub. Date: Feb. 26, 2009

(54) Pastuerization alternative for blackcurrant pomace, juice and powder

(76) Inventors: Ross G. Fry, Motueka (NZ); Janice B. Fry, Motueka (NZ); Neil S. Boyd, Picton (NZ)

Correspondence Address: Robert Charles Hill, 235 Montgomery Street # 821, San Francisco, CA, 94104, US

(21) Appl. No.: 11/895,413

(22) Filed: Aug. 24, 2007

(51) Int. Cl. A23L 3/46; A23L 3/40

(52) U.S. Cl. 426/640

(57) ABSTRACT

A pasteurization alternative comprises starting with a fruit pomace (pulp). For example, blackcurrant pomace usually starts at about 50% water. It can either be dried first or treated directly with alcohol. If direct, the undried pomace is treated with ethanol or propanol such that there is a minimum of 20% alcohol in the volatile phase. If dried first, the pomace is dried in an air, vacuum, or freeze dryer, keeping temperatures under 45° C. (113° F.). The alcohol is then sprayed over the dried pomace, such that all surfaces will be coated with it. After 1-5 minutes contact time, the alcohol is evaporated off under vacuum and recovered for the next batch.

### BACKGROUND

1. Field of the Invention

The present invention relates to pasteurization alternatives for fruit juices, powders, and pomace, and more particularly to low-heat processes for blackcurrant pomace that effectively zero the yeast and mold counts without damaging the delicate nutritional values so unique to blackcurrants.

2. Description of the Prior Art

Shelf-life and disease control concerns necessitate that beverages be pasteurized or otherwise sterilized. But such processes can introduce enough heat to damage inulin, anthocyanins, and anti-oxidants if included in the product. Once damaged, these materials lose their beneficial characteristics, and the beverage's flavor can be adulterated.

Blackcurrants and other vine-grown fruits like grapes have naturally occurring yeasts and molds on their skin surfaces. Such yeasts and molds will cause the product shelf lives to be very short, and there have been a few serious outbreaks of disease associated with unpasteurized products. So pasteurization is widely used to essentially sterilize the product, and zero out the bad microorganisms.

Pasteurization exposes the bad microorganisms to a minimum heat for a minimum time, e.g., so-called high temperature short time (HTST) pasteurization of milk can produce a 5-log kill (99.999%). HTST holds the product at 161° F. for 15-seconds. Batch/vat pasteurization uses 145° F. for 30-minutes. Ultra high temperature (UHT) pasteurization takes the product past its boiling point for up to a few seconds, e.g., 250+° F. for 0.1 seconds, but such is well-known to adversely affect the flavor of the finished product.

Alcohol is generally recognized for its ability to sterilize and kill bacteria. In fact, ethanol is a waste product of bacteria. Allen C. Kryger describes using added alcohol to skip the second pasteurization step usually needed in packaging orange juice, in U.S. Pat. No. 4,534,991, issued Aug. 13, 1985. The alcohol is used to make an aseptic flavor system, but such alcohol remains in the finished product, and a first pasteurization step is still employed.

In particular, a sterilization method is needed as an alternative to pasteurization in the manufacture of powders from blackcurrant pomace. Blackcurrants are an excellent source of essential fatty acids (EFA), including gamma linoleic acid (GLA). If heat can be avoided, the resulting blackcurrant powder will retain all its flavor and health characteristics and yet be safe to use with extended shelf-life as a powder.

### SUMMARY OF THE INVENTION

Briefly, a pasteurization alternative embodiment of the present invention comprises starting with a fruit pomace (pulp) or juice. For example, blackcurrant pomace usually starts at about 50% water. It can either be dried first or treated directly with alcohol. If direct, the undried pomace is treated with ethanol or propanol such that there is a minimum of 20% alcohol in the volatile phase. If dried first, the pomace is dried in an air, vacuum, or freeze dryer, keeping temperatures under 45° C. (113° F.). The alcohol is then sprayed over the dried pomace, such that all surfaces will be coated with it. After 1-5 minutes contact time, the alcohol is evaporated off under vacuum and recovered for the next batch.

An advantage of the present invention is that a blackcurrant powder is provided that retains all its flavor and nutritional characteristics.

Another advantage of the present invention is that a pasteurization alternative is provided for the food industry.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is a flowchart diagram of a first method embodiment of the present invention for alcohol treating and making fruit powders by drying the input feed of pomace;

FIG. 2 is a flowchart diagram of a second method embodiment of the present invention for direct alcohol treatment of the input feed of pomace and making fruit powders; and

FIG. 3 is a functional block diagram of a system embodiment of the present invention for alcohol treatment of the input feed of pomace suitable for making blackcurrant powders.

### DETAILED DESCRIPTION OF THE PREFERRED EMBODIMENT

Blackcurrants are reported to be more beneficial to its users than other kinds of fruits and juices. A blackcurrant pomace (pulp) mixed from more than one variety is in particular very desirable for the production of powder. Alternative powders include, but are not limited to blueberry, boysenberry, cranberry, black cherry, and a wide variety of other fruit and vegetables.

A pasteurization alternative comprises starting with a fruit pomace. For example, blackcurrant pomace usually starts at about 50% water. It can either be dried first or treated directly with alcohol. If direct, the undried pomace is treated with ethanol or propanol such that there is a minimum of 20% alcohol in the volatile phase. If dried first, the pomace is dried in an air, vacuum, or freeze dryer, keeping temperatures under 45° C. (113° F.). The alcohol is then sprayed over the dried pomace, such that all surfaces will be coated with it. After 1-5 minutes contact time, the alcohol is evaporated off under vacuum and recovered for the next batch.

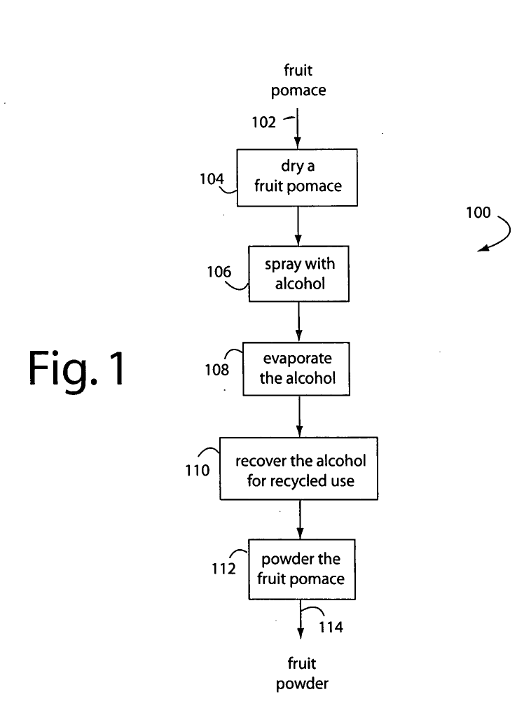

FIG. 1 represents a first method embodiment of the present invention for manufacturing a fruit powder, and is referred to herein by the general reference numeral 100. The method 100 starts with a fruit pomace 102. In a particularly valuable food product, the fruit pomace 102 principally comprises varieties of blackcurrants.

The method comprises a step 104 for drying the fruit pomace with an air, vacuum, or freeze dryer, keeping temperatures under 45° C. (113° F.). In a step 106, the fruit pomace, after being dried, is sprayed with alcohol, either ethanol or propanol, such that all pulp surfaces are contacted for 1-5 minutes. In a step 108, the alcohol is vacuum evaporated to remove it from the fruit pomace. In a step 110, the alcohol that was evaporated is recovered for repeated use. A step 112 makes a powder 114 from the treated fruit pomace that is suitable for use as a food supplement and as an ingredient for other products.

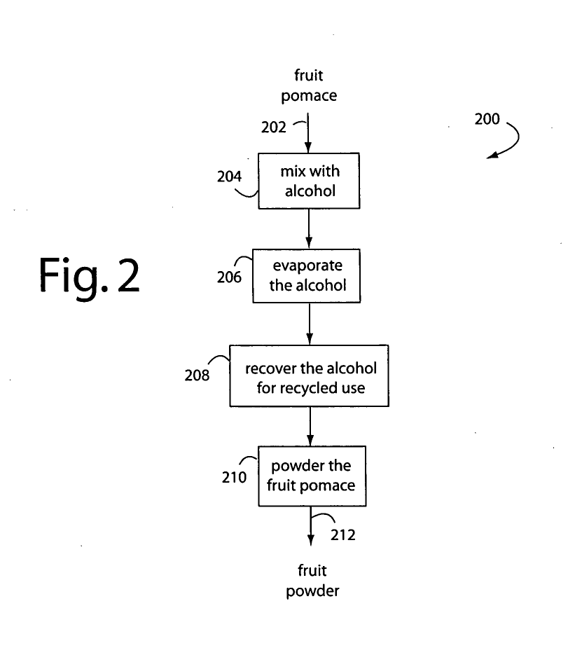

FIG. 2 represents a second method embodiment of the present invention for manufacturing a fruit powder, and is referred to herein by the general reference numeral 200. The method 200 starts with a fruit pomace 202, and a step 204 mixes it with alcohol, either ethanol or propanol, such that all pulp surfaces are contacted for 1-5 minutes. In a step 206, the alcohol is vacuum evaporated to remove it from the fruit pomace. In a step 208, the alcohol that was evaporated is recovered for repeated use. A step 210 produces a powder 212 from the treated fruit pomace, and such powder is suitable for use as a food supplement and as an ingredient for other products.

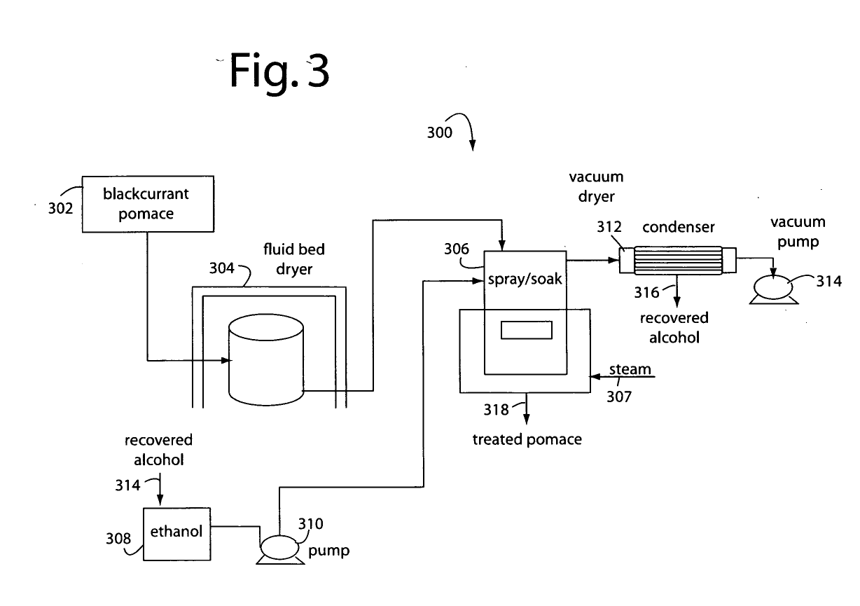

FIG. 3 represents a system embodiment of the present invention for manufacturing a blackcurrant powder, and is referred to herein by the general reference numeral 300. System 300 comprises a feed 302 of pomace, e.g., blackcurrants, that are sent to a fluid bed dryer 304. The pomace is dried and sent for spraying/soaking with alcohol in a device 306 with steam injection 307. For example, an ethanol 308 is provided by a pump 310. After treatment, vacuum drying allows a condenser 312 and vacuum pump 314 to recover alcohol 316 for recycling. A treated pomace 318 can then be converted to a blackcurrant powder that does not need traditional pasteurization.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. A method for manufacturing a fruit powder, comprising:
drying a fruit pomace with an air, vacuum, or freeze dryer, keeping temperatures under 45° C. (113° F.);
spraying said fruit pomace after being dried with alcohol, either ethanol or propanol, such that all pulp surfaces are contacted for 1-5 minutes;
vacuum evaporating said alcohol to remove it from said fruit pomace;
recovering the alcohol that was evaporated for repeated use; and
reducing said fruit pomace to a powder.

2. The method of claim 1, wherein the steps are such that said fruit pomace principally comprises at least one variety of blackcurrant.

3. A method for manufacturing a fruit powder, comprising:
starting with a fruit pomace having about 50% water;
mixing said fruit pomace with alcohol, either ethanol or propanol, such that all pulp surfaces are directly contacted for 1-5 minutes, with a minimum of 20% alcohol in the volatile phase;
vacuum evaporating said alcohol to remove it from said fruit pomace;
recovering the alcohol that was evaporated for repeated use; and
reducing said fruit pomace to a powder.

4. The method of claim 3, wherein the steps are such that said fruit pomace principally comprises blackcurrant.

5. The product of the process of claim 1.

6. The product of the process of claim 3.

7. The method of claim 1 wherein said powder is suitable for use as a food supplement.

8. The method of claim 1 wherein said powder is suitable for use as an ingredient for other products.
